(19) United States
(12) Patent Application Publication
(10) Pub. No.: US 2010/0170245 A1
(43) Pub. Date: Jul. 8, 2010

(54) TURBOCHARGER CONFIGURATION AND TURBOCHARGEABLE INTERNAL COMBUSTION ENGINE

(75) Inventors: Dick Amos, Lincoln (GB); Ulrich Bast, Munchen (DE); Francis Heyes, Lincoln (GB); Norbert Huber, Erlangen (DE); Andre Kaufmann, Baienfurt (DE); Achim Koch, Tegernheim (DE); Georg Mehne, Wenzenbach (DE); Gerhard Schopp, Pettendorf (DE); Udo Schwerdel, Gerolsheim (DE); Markus Teiner, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Muenchen (DE)

(21) Appl. No.: 12/596,261

(22) PCT Filed: Apr. 8, 2008
(86) PCT No.: PCT/EP2008/054236

§ 371 Date: Mar. 16, 2010

(30) Foreign Application Priority Data
Apr. 16, 2007 (DE) 10 2007 017 777.3

(51) Int. Cl. F02B 33/44

(52) U.S. Cl. 60/607

(57) ABSTRACT

A turbocharger configuration, particularly in or for a motor vehicle, includes at least one turbocharger stage, which has a turbine and a compressor that are mechanically decoupled from each other. A turbochargeable internal combustion engine having such a turbocharger configuration, is also provided.

The invention relates to a turbocharger configuration, in particular in or for a motor vehicle, as well as to a turbochargeable internal combustion engine having such a turbocharger configuration.

In conventional, non-supercharged internal combustion engines (Otto (spark ignition) or diesel engine), when air is aspirated there is created in the induction tract a vacuum which builds up as the revolutions per minute of the engine increases and which limits the theoretically attainable performance of the engine. One possibility of counteracting this effect and thereby achieving a boost in performance is to use an exhaust gas turbocharger (EGT). An exhaust gas turbocharger, or turbocharger for short, is a supercharging system for an internal combustion engine by means of which an increased charge air pressure is applied to the cylinders of the internal combustion engine.

The detailed structure and mode of operation of a turbocharger of said type is generally known and is therefore explained only briefly below. A turbocharger consists of an exhaust gas turbine in the exhaust gas stream (downstream path) which is typically connected in a mechanically rigid manner via a common shaft to a compressor in the induction tract. The turbine is set into rotation by the exhaust gas stream from the engine and thereby drives the compressor. The compressor increases the pressure in the induction tract (upstream path) of the engine such that as a result of said compression a greater volume of air is drawn into the cylinders of the internal combustion engine during the induction stroke than in the case of a conventional naturally-aspirated engine. More oxygen is available for combustion as a result. This increases the mean effective pressure of the engine and its torque, thereby significantly improving the power delivery. Supplying a greater volume of fresh air combined with the compression process is called supercharging. The energy for the supercharging is taken from the fast-flowing, hot exhaust gases by the exhaust gas turbine. This energy, which would otherwise be lost through the exhaust system, is used to reduce induction losses. This type of supercharging increases the overall efficiency of a turbocharged internal combustion engine.

The same high demands as are placed on conventional internal combustion engines with an equal power rating are also applicable to the mode of operation of drive units equipped with turbochargers. The result is that the full charge air pressure of the exhaust gas turbocharger must be available already even at very low engine speeds in order to reach a required engine power. This is not always possible, however. When accelerating from low rotational speeds, the right exhaust gas volume for generating the charge pressure for the aspirated fresh air in the upstream path is initially absent from the downstream path. The desired compression of the aspirated fresh air and hence the desired supercharging only kicks in when a sufficiently strong exhaust gas stream is available, for example as the rotational speed increases. This lack of power at low rotational speeds is generally referred to as turbo lag. Said turbo lag results essentially due to the typically rigid mechanical coupling between turbine and compressor.

In order to avoid turbo lag, closed-loop control systems specifically provided therefor can be used, such as, for example, a variable turbine geometry (VTG). However, said systems are complex and costly in manufacturing and design terms.

A further possibility resides in the use of a two-stage or multi-stage turbocharger. Each of said turbocharger stages has its own turbine and its own compressor which are jointly coupled to each other via a shaft. Although the problem of a turbo lag is reduced in the case of such turbochargers, it is nonetheless still present. This is due to the still present rigid mechanical coupling of turbine and compressor.

Although contemporary turbochargers actually use a two-stage supercharging system, a turbocharger stage has only one compressor which instead of being driven by a turbine is driven by a connectable electric motor (a so-called e-booster). A rigid mechanical coupling is present in this case too, however. Moreover, due to the absence of a turbine for the electrically drivable compressor the energy in the exhaust system of the turbocharger is not used to optimal effect. A compressor of said type driven via an electric motor is described for example in the German patent application DE 100 23 022 A1.

In modern motor vehicles there is always the requirement to utilize the space available in the engine compartment effectively. As a result more compact turbochargers are also required. However, the degree of freedom in the configuration and design of the turbocharger and at the same time in particular its fresh air and exhaust gas ducts inside the turbocharger housing is limited. This is due among other things to the rigid mechanical coupling between compressor and turbine.

In modern turbocharged internal combustion engines there is additionally the problem that the turbocharger is disposed either on the air intake manifold side or on the exhaust manifold side of the engine. Depending on which side the turbocharger is arranged, more or less long pipelines are also present for connecting the turbocharger to the engine. This is disadvantageous firstly for fluidic reasons. Secondly, very long pipe lengths also result in a reduction in the amount of space available inside the engine compartment.

Against this background it is an object of the present invention to provide a turbocharger whose upstream path and downstream path can be designed largely independently of each other.

A further object consists in disclosing a turbocharger whose connecting pipes to the exhaust manifold and air intake manifold of the internal combustion engine are embodied to be as short as possible.

A further object consists in reducing the undesirable effect of turbo lag in a turbocharger.

A further object consists in providing a turbocharger whose design is tailored to and optimized for the closed loop of the working media of an internal combustion engine.

According to the invention at least one of the stated objects is achieved by means of a turbocharger having the features recited in claim 1 and/or by means of an internal combustion engine having the features recited in claim 17.

Accordingly there is provided:
A turbocharger configuration, in particular in or for a motor vehicle, comprising at least one turbocharger stage that has a turbine and a compressor which are mechanically decoupled from each other.
A turbochargeable internal combustion engine, comprising an engine that has a crankshaft as well as an air intake manifold and an exhaust manifold, comprising an inventive turbocharger configuration which is connected by means of its upstream path to the air intake manifold via corresponding intake pipes and which is connected by means of its downstream path to the exhaust manifold via exhaust pipes.

The concept underlying the present invention consists in providing a turbocharger or, as the case may be, a correspondingly turbocharged internal combustion engine in which the downstream side and the upstream side of the turbocharger are mechanically decoupled from each other. As a result of said mechanical decoupling the turbocharger has an additional degree of freedom which can be used in particular in the design and configuration of the downstream and upstream sides of the turbocharger housing.

In particular the turbine and the compressor of the turbocharger must now no longer be arranged very close to each other in order to provide a compact turbocharger. Rather, the turbine of the turbocharger, for example, can be installed as close as possible to the exhaust manifold and at the same time the compressor of the turbocharger can likewise be disposed close to the air intake manifold of the engine. Thus, only a short length of piping is required both between turbine and exhaust manifold on the one side and between compressor and air intake manifold on the other side, with the result that said parts of the turbocharger can be efficiently designed specifically to match the respective engine layout and to that extent piping-related flow losses can also be largely avoided.

This is of particular advantage in particular on the upstream side, since in this case the compressor should be arranged as close as possible to the intake side of the engine for the purposes of pressure charging. On this side in particular it is important for achieving a high degree of efficiency of the turbocharger that as short a length of piping as possible is present between the outlet of the compressor and the air intake manifold of the engine so that the compressor will be in a position to make the necessary intake pressure available to the engine very quickly. This is now possible owing to the inventive mechanical decoupling of turbine and compressor. A minimum volume can now be realized in the intake-side pipeline, in which volume the pressure generated by the compressor can be very rapidly built up. The turbo lag can thus be effectively avoided or at least largely eliminated.

A further advantage of the mechanical decoupling consists in the fact that compressor and turbine of a turbocharger can now be designed to match the design of the engine, at the same time its air intake manifold and exhaust manifold, more closely.

A further requirement for a turbocharger is that the fresh air compressed by the compressor should be as cool as possible in order thereby to provide a highest possible degree of efficiency in the combustion of fuel in the engine. During the combustion of the fuel, hot exhaust gas is generated which drives the turbines of the turbocharger and in the process effectively heats the turbine-side elements of the turbocharger. Due to the former mechanical coupling the common shaft acts in a certain way as a heat bridge and undesirably contributes toward transmitting the turbine-side heat to the compressor, thereby leading to an undesirable heating of the air supplied on the fresh air side. Owing to the inventive mechanical decoupling of compressor and turbine this effect no longer exists. In the absence of a common shaft the compressor can no longer be heated by the turbine. The compressed air generated by the compressor is therefore cooler and thereby ensures an improved level of efficiency in the engine of the internal combustion engine.

Advantageous embodiments and developments of the invention will emerge from the further dependent claims as well as from the description in conjunction with the drawing.

In a preferred embodiment the turbine and the compressor of a turbocharger stage are coupled to each other by electromechanical means. Electromechanical is used in the sense that no direct mechanical connection is present between the turbine and the corresponding compressor, but instead only an electrical connecting or coupling device is present.

In one embodiment the turbine has a first shaft and the compressor a second shaft which is mechanically decoupled from the first shaft. The first shaft and the second shaft are coupled to each other only by means of an electrical coupling device.

In a first preferred embodiment the turbine is coupled via the first shaft directly to a generator, the generator being designed to generate electrical energy from the kinetic energy of the turbine wheel which is driven by the hot exhaust gas. In addition or alternatively it can also be provided that the turbine is coupled to the generator via a first gear unit. The use of a speed-increasing or speed-reducing gear is beneficial in order to match the generator optimally to its nominal rotational speed and hence to the maximum efficiency of the generator.

In a further preferred embodiment the compressor is mechanically coupled via the second shaft to an electric motor. The electric motor is designed to drive the compressor and in particular its compressor wheel from the electrical energy supplied to it. In addition or alternatively a second gear unit can be provided via which the electric motor is coupled to the compressor. In this case the second gear unit ensures that a corresponding rotational speed is provided for the compressor wheel.

A preferred embodiment provides that the generator is connected to the electric motor via an electrical coupling device, for example a supply line. The generator is designed to supply the electric motor with electrical energy via said coupling device or, as the case may be, supply line.

In a particularly preferred embodiment the generator is embodied as a synchronous machine or as an asynchronous machine. In this case the generator can act as a controllable generator.

In a likewise preferred embodiment the electric motor is also embodied as an asynchronous motor or as a synchronous motor. In this case the electric motor can be employed as a drive motor for driving the compressor and also used as a braking device. In the latter case the electric motor can brake the compressor such that the compressor acts to a certain extent as a throttle valve and thus assists in the braking of the engine. In this case the compressor would no longer generate the desired charge pressure for the engine, with the result that the engine of the internal combustion engine is no longer supplied with sufficient fresh air, which ultimately leads to the braking of the engine.

Typically the compressor has a higher rotational speed than is provided by conventional electric motors. In a particularly preferred embodiment the second (electric motor) gear unit is therefore embodied as a speed-increasing gear in order to generate the high rotational speeds of the compressor. In the same way the turbine mostly has a higher rotational speed than conventional generators can process. In an alternative embodiment the first (generator) gear unit is therefore embodied as a speed-reducing gear. In any event the first and second gear unit are matched to the generator or electric motor assigned in each case and at the same time are adapted in particular to their nominal rotational speeds and power outputs. In this way the efficiency of the generator or, as the case may be, of the electric motor can be optimized for the respective speeds of revolution of the turbine wheel and the compressor wheel.

In a particularly preferred embodiment an energy storage device is provided (as part of the electrical coupling device). In this case the energy storage device is fed by the generator. Said energy storage device can supply the electric motor with electrical energy as necessary via a supply line specifically provided therefor and thus enable the compressor to be driven by the electric motor. In this way the compressor can then be supplied with energy precisely when the compressor is required to provide the desired compressor power output. In this way a decoupling of the rotational speeds of the turbine and the compressor is realized, which also leads inter alia to a minimization of the undesired effect of turbo lag. At the same time this also prevents the turbine and consequently also the compressor from rotating at increasingly high speeds and the compressor from reaching its capacity limit due to a back-coupling of the speed of revolution of the compressor onto the turbine, and the mechanical and thermal limits of the engine being exceeded. Too great a turbine power output is advantageously buffered in the energy storage device. Said energy is drawn upon by the electric motor when the compressor is required to provide the desired compressor power output.

In one embodiment the energy storage device is embodied as a storage battery, a supercap capacitor (or supercap for short) and/or a high-performance capacitor. A supercap is particularly preferred in this case because it has the capacity to store large amounts of electrical energy in a short time. The service life of such a supercap is also significantly longer than that of a corresponding storage battery.

In a particularly preferred embodiment the turbine and the compressor mechanically decoupled from said turbine are integrated in a common turbocharger housing. This embodiment permits a very compact implementation of the turbocharger.

In an alternative, likewise very advantageous embodiment a first turbocharger housing is provided in which the compressor is arranged. In addition a second, typically separate turbocharger housing that is different from the first turbocharger housing is provided inside which the turbine is arranged. The electric motor is arranged in the first housing and the generator in the second housing. The turbine and the compressor are coupled to each other via electrical connecting lines. In this way the compressor of the turbocharger can be positioned in relative proximity to the air intake manifold of the internal combustion engine. In addition the turbine of the turbocharger can also be positioned in relative proximity to the exhaust manifold. In this way the pipe lengths between compressor and air intake manifold or, as the case may be, between exhaust manifold and turbine become very short, thereby minimizing flow losses. The efficiency of such a turbocharger is optimized as a result. This embodiment enables a compact design of the turbocharger that is optimized to the design of the internal combustion engine.

In a particularly preferred embodiment no waste-gate bypass device is required for the downstream path of the turbocharger. Such a waste gate is necessary in the case of conventional turbochargers in order to inhibit an excessively great increase in the turbine's rotational speed, in order—as explained hereintofore—to prevent the turbine and hence also the compressor of the turbocharger from rotating at increasingly high speeds, which due to their mechanical coupling can lead to the engine's exceeding its mechanical and thermal limits. Since the turbine and the compressor are now mechanically decoupled from each other, this danger no longer exists.

In a particularly preferred embodiment the turbocharger configuration is embodied as two-stage, wherein a first turbocharger stage is embodied as a high-pressure stage comprising a high-pressure turbine and a high-pressure compressor. The second turbocharger stage is embodied as a low-pressure stage comprising a low-pressure turbine and a low-pressure compressor.

In an alternative, likewise preferred embodiment of the invention the turbine and the compressor of the same turbocharger stage are coupled to each other at least partially pneumatically and/or hydraulically. At least partially, in this context, means that while mechanical elements are by all means provided, the turbine and the compressor of a respective turbocharger stage are not coupled to each other exclusively mechanically.

In a particularly preferred embodiment of the internal combustion engine the generator of the turbocharger configuration is part of the alternator. In this way a dedicated generator specifically provided for the turbine of the turbocharger configuration can be dispensed with.

The internal combustion engine preferably has an integrated starter/generator which is connected to the crankshaft or, as the case may be, driveshaft of the engine. Such a starter/generator is a three-phase asynchronous motor which can operate both as a starter and as a generator.

The generator and/or the electric motor of the turbocharger configuration are/is preferably connected to the starter/generator via respective supply lines. The starter/generator, to the extent that it functions as a starter, can preferably be supplied with electrical energy by the turbocharger via the supply line to the generator of the turbocharger. In addition or alternatively the starter/generator, to the extent that it acts as a generator in this case, can effectively supply the electric motor with energy via a further supply line to the electric motor of the turbocharger. In this case an energy storage device specifically provided therefor can be dispensed with.

Preferably, however, an intelligent energy management system is used which integrates the starter/generator, the power supply, the generator of the turbocharger and/or the electric motor of the turbocharger with one another, this preferably being controlled via a dedicated control device specifically provided for that purpose.

In a particularly preferred embodiment the turbochargeable internal combustion engine also includes an additional electric drive for driving the crankshaft and is therefore embodied as a hybrid engine.

The invention is explained in more detail below with reference to the exemplary embodiments depicted in the figures of the drawings, in which:

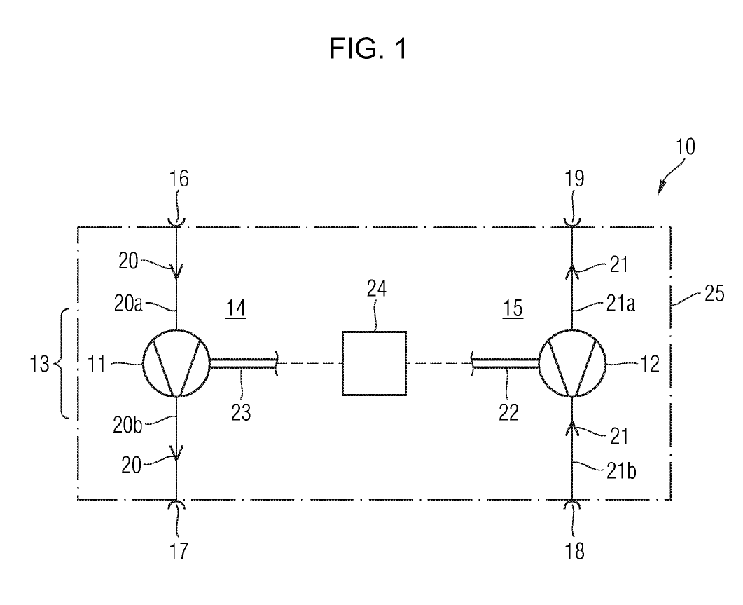

FIG. 1 shows a simplified representation of a first exemplary embodiment of a turbocharger according to the invention;

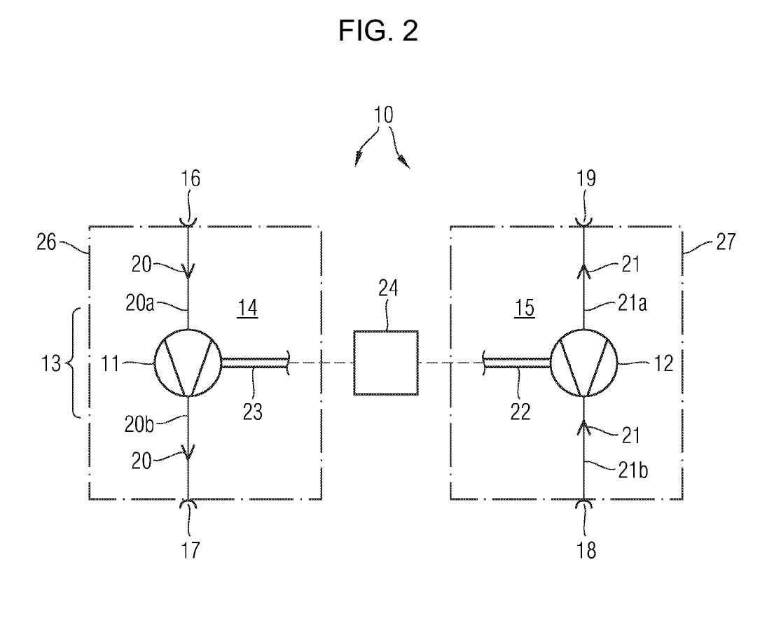

FIG. 2 shows a simplified representation of a second exemplary embodiment of a turbocharger according to the invention;

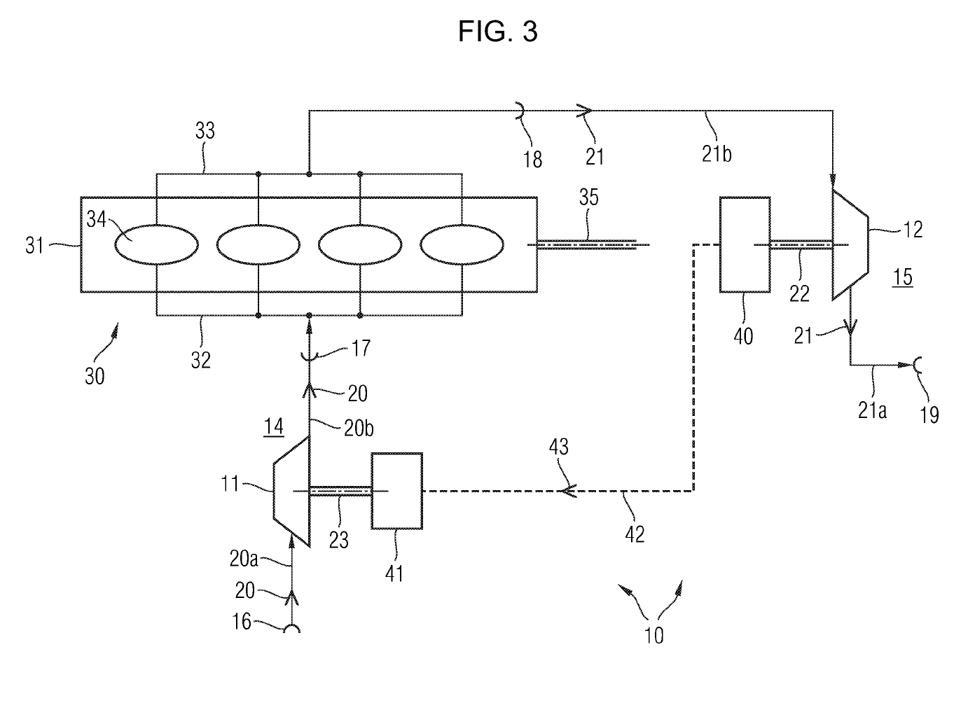

FIG. 3 shows a schematic representation of a first exemplary embodiment of an internal combustion engine according to the invention;

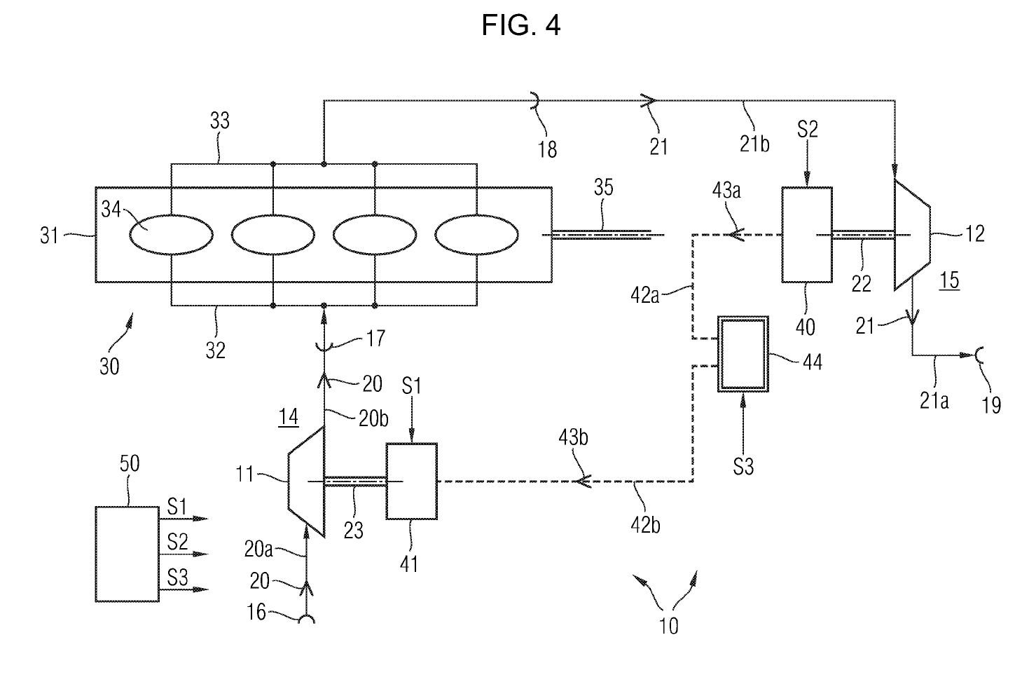

FIG. 4 shows a schematic representation of a second exemplary embodiment of an internal combustion engine according to the invention;

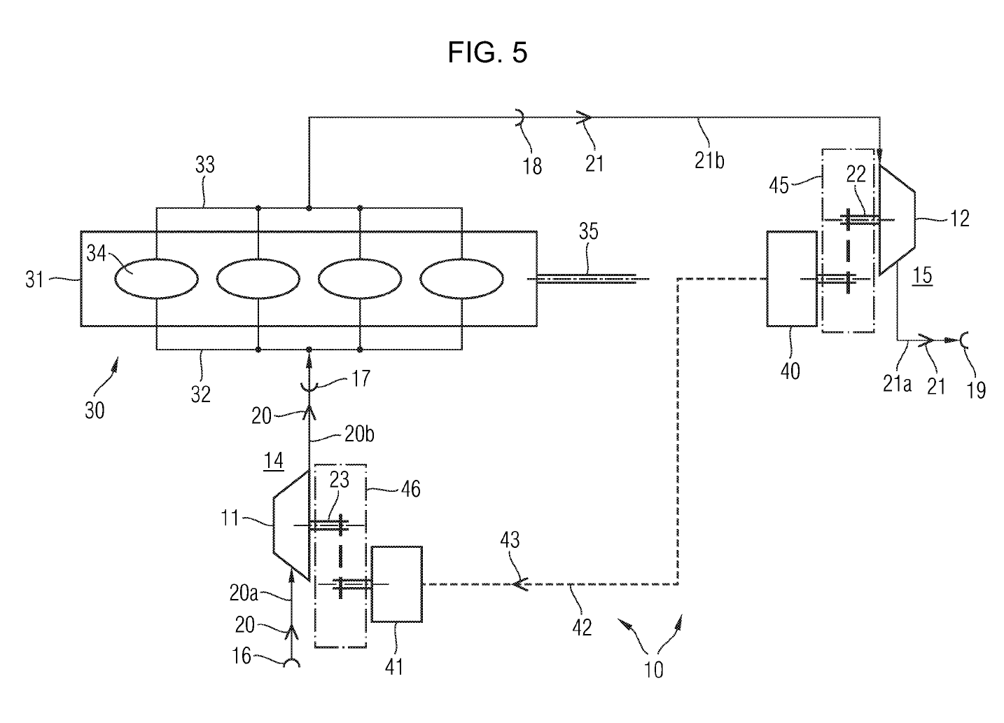

FIG. 5 shows a schematic representation of a third exemplary embodiment of an internal combustion engine according to the invention; and

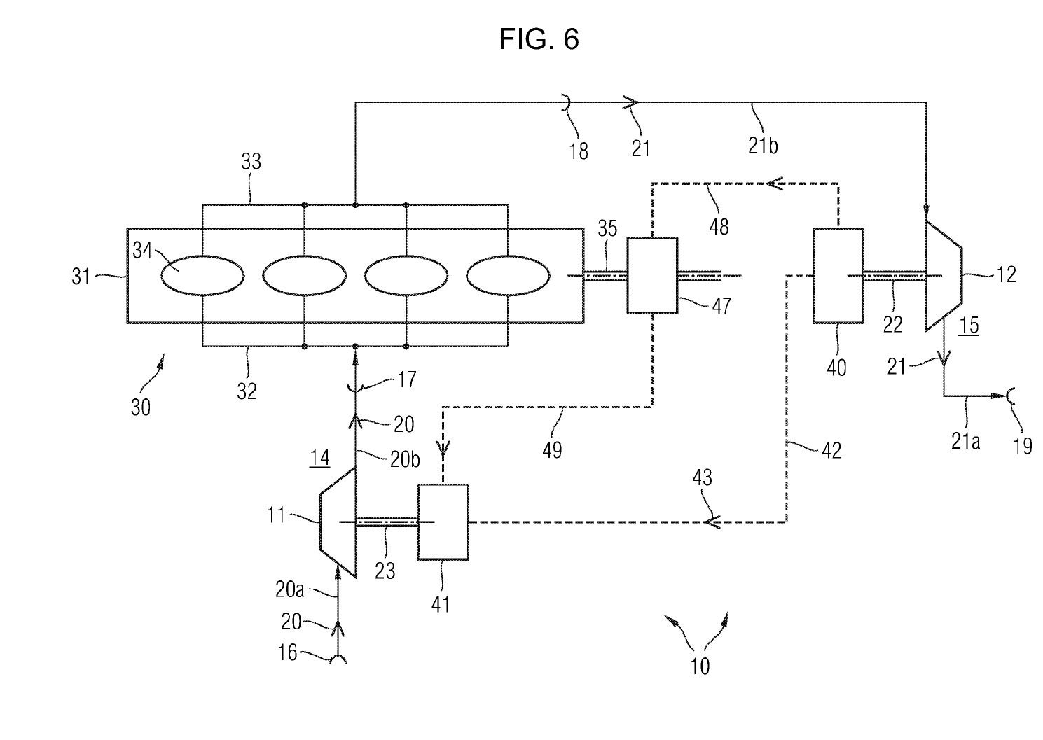

FIG. 6 shows a schematic representation of a fourth exemplary embodiment of an internal combustion engine according to the invention.

Unless otherwise indicated, identical and functionally identical elements, features and dimensions are labeled with the same reference signs throughout the figures of the drawings.

FIG. 1 shows a schematic representation of a first exemplary embodiment of an inventive turbocharger, greatly simplified, which has only the essential component parts of a turbocharger. The turbocharger 10 labeled with reference sign 10 has a compressor 11 and a turbine 12. The turbocharger 10 in FIG. 1 is embodied as one-stage, i.e. it has only one turbocharger stage 13. The compressor 11 is arranged in an upstream path 14 and the turbine 12 in a downstream path 15. The upstream path 14 of the turbocharger 10 is defined between a fresh air inlet 16, via which fresh air is aspirated, and a fresh air outlet 17, via which fresh air compressed by the compressor 11 is provided by the turbocharger 10. Said output compressed fresh air is supplied to a fresh air inlet side of an internal combustion engine (not shown in FIG. 1). The downstream path 15 of the turbocharger 10 is defined between an exhaust gas inlet 18, via which exhaust gas generated by the internal combustion engine (not shown in FIG. 1) is introduced into the turbocharger 10, and an exhaust gas outlet 19, via which the exhaust gas can escape. The upstream path 14 is frequently also referred to as the induction tract, fresh air side, compressor side or charge air side. The downstream path 15 is frequently also referred to as the exhaust path or exhaust side.

With regard to the terminology chosen in the present patent application, an individual compressor 11 has an inlet on the input side and an outlet on the output side. The flow direction in the upstream path 14 and downstream path 15 is determined by the flow air of the fresh air 20 and of the exhaust gas 21, respectively. The flow direction of the fresh air 20 and of the exhaust gas 21 is indicated by means of corresponding arrows in all the figures.

A first pipe 20a is provided between the fresh air inlet 16 and the inlet of the compressor 11. Also provided is a further pipe 20b between the outlet of the compressor 11 and the fresh air outlet 17. In the same way a pipe 21b is provided between the exhaust gas inlet 18 and the turbine 12 and a second pipe 21a is provided between the turbine 12 and the exhaust gas outlet 19.

The turbine 12 or its turbine wheel is fixedly coupled to a first shaft 22. Accordingly the turbine wheel drives the first shaft 22. In addition the compressor 11 or its compressor wheel is fixedly coupled to a second shaft 23. The compressor 11 is driven via the second shaft 23. The first shaft 22 of the turbine 12 is thus completely decoupled mechanically from the second shaft 23 of the compressor 11. That said, the turbine 12 and the compressor 11 are nonetheless coupled to each other electrically via an electrical coupling device 24. The embodiment of said coupling device 24 is described in detail below with reference to FIGS. 3-6.

In the exemplary embodiment shown in FIG. 1 the compressor 11 and the turbine 12 and preferably also the coupling device 24 are fully integrated in a common turbocharger housing 25.

In contrast thereto, in the exemplary embodiment shown in FIG. 2 the compressor 11 and the second shaft 23 are arranged in a first turbocharger housing 26. The turbine 12 together with the first shaft 22 is arranged in a different, second turbocharger housing 27 that may also be separate from the first turbocharger housing 26. The electrical coupling device 24 can, as in the example shown, be arranged outside of the first and second turbocharger housing 26, 27 or also alternatively in the first housing 26 and/or the second housing 27.

FIG. 3 shows a schematic representation of a first exemplary embodiment of an internal combustion engine according to the invention. In the exemplary embodiment shown in FIG. 3, in contrast to that in FIG. 1, the internal combustion engine 30 is shown in addition. The engine 31 has a driveshaft 35, the so-called crankshaft 35. In the present exemplary embodiment the engine block 31, or engine 31 for short, of the internal combustion engine 30 has four cylinders 34, though this is to be understood as merely exemplary. The internal combustion engine 30 and the coupling to the turbocharger 10 are also depicted in greatly simplified form in this case.

The engine 31 of the internal combustion engine 30 has an air inlet side 32 (air intake manifold) and an exhaust gas outlet side 33 (exhaust manifold). The air inlet side 32 is in this case connected to the fresh air outlet 17 of the turbocharger 10 and the exhaust gas outlet side 33 is connected to the exhaust gas inlet 18 of the turbocharger 10.

In the exemplary embodiment shown in FIG. 3 there is provided in the downstream path 15 a generator 40 (e.g. as part of the turbocharger or also outside of the latter's housing) which is connected to the turbine 12 in a mechanically rigid manner via the first shaft 22. When the turbine wheel of the turbine 12 is driven via the exhaust gas stream 21, said turbine wheel drives the generator 40 via the first shaft 22. The generator 40 generates electrical energy from this kinetic energy.

The generator 40 can also be, for example, the generator of an alternator that is already present in a motor vehicle anyway. In this case a dedicated generator specifically provided for the turbine 12 can be dispensed with.

An electric motor 41 is provided in the upstream path 14. The electric motor 41 is mechanically connected to the compressor wheel of the compressor 11 via the second shaft 23. The electric motor 41 is designed to drive the compressor wheel via the second shaft 23, said compressor wheel subsequently compressing the fresh air 20 supplied to the compressor 11 and feeding it to the engine 31 of the internal combustion engine 30. In the exemplary embodiment shown in FIG. 3 the electrical energy required by the electric motor 41 for that purpose is supplied to it directly by the generator 40 via a supply line 42. For example, the generator 40 generates a current 43 which is fed to the electric motor 41 via the supply line 42 and which drives the electric motor 41 and hence also the compressor wheel.

In contrast to the exemplary embodiment shown in FIG. 3, the internal combustion engine shown in FIG. 4 additionally has a rechargeable energy storage device 44. In FIG. 4 the energy storage device 44 is embodied as a supercap which is designed to release the stored energy again very quickly. On the supply side the energy storage device 44 is connected to the generator 40 via a first supply line 42a. In addition, on the output side, the chargeable energy storage device 44 is connected via a second supply line 42b to the electric motor 41. The energy storage device 44 is thus supplied via the supply line 42a with a current 43a and/or a voltage 43a by means of which the energy storage device 44 is charged. The energy storage device 44 delivers a current or a voltage 43b to the electric motor 41 via the supply line 42b.

The advantage here lies in the fact that all the kinetic energy of the turbine 12 can now be converted into electrical energy and can be requisitioned from the energy storage device 44 via the electric motor 41 only as and when it is needed, insofar as the compressor 11 requires the corresponding compressor power. In this case there is therefore an optimal utilization of the kinetic energy of the turbine 12 with regard to the efficiency of the compressor 11 and the turbine 12.

FIG. 4 also shows a control device 50. The control device 50 can be embodied as part of the turbocharger 10 of the internal combustion engine 30 or also as a control device independent thereof, for example as part of the engine control unit. The control device 50 is embodied to control the electric motor 41, the generator 40 and the energy supply 44 via control signals S1-S3 such that an optimal level of efficiency is achieved by means of the generator 40 and the electric motor 41.

In the exemplary embodiment shown in FIG. 5, in contrast to the exemplary embodiment shown in FIG. 3, a first gear unit 45 is provided between the generator 40 and the turbine 12. Said gear unit 45 is designed to convert the revolutions of the turbine wheel to a desired nominal revolution of the generator 40. A clutch, for example, can preferably also be provided here via which, for example, different speeds of revolution of the turbine 12 can be converted. In the same way a second gear unit 46 is provided between the compressor 11 and the electric motor 41. The gear unit 46 is designed to convert a speed of revolution provided by the electric motor 41 to a desired speed of revolution of the compressor wheel 11.

The turbine wheel typically has a very high speed of revolution of, for example, 50-200,000 revolutions per minute, while commonly available generators are designed for nominal speeds of revolution in the range of several 10,000 revolutions per minute. In this case it is beneficial to convert or, in this case, reduce the high number of revolutions of the turbine wheel by means of a gear unit specifically to the optimal rotational speed of the generator. For this reason the first gear unit 45 is preferably embodied as a speed-reducing gear. For a similar reason the second gear unit 46 is preferably embodied as a speed-increasing gear.

In the exemplary embodiment shown in FIG. 6, in contrast to the exemplary embodiment shown in FIG. 3, an additional motor 47 is provided which is coupled via the crankshaft 35. In the example in FIG. 6 the additional motor is embodied as an integrated starter/generator 47 which can act both as a starter and as a generator. The starter/generator 47 is connected to the generator 40 via a supply line 48. When the starter/generator functions as a starter it can be supplied with energy for starting the engine 31 via the generator 40 and the supply line 48. The integrated starter/generator 47 is additionally connected to the electric motor 41 via a second supply line 49. When the starter/generator operates as a generator, it can feed the acquired electrical energy to the electric motor 41 via the supply line 49.

The present invention is not restricted to the above-described exemplary embodiments, but can of course be modified in a multiplicity of ways.

In the above-described exemplary embodiments of a turbocharger 10 (FIGS. 1 and 2) and an internal combustion engine 30 (FIGS. 3 to 6) these were presented in relatively simple terms in the interests of providing a better explanation of the invention. It goes without saying that a turbocharged internal combustion engine self-evidently also includes a charge-air intercooler, an exhaust gas outlet system, which contains e.g. a catalytic converter, an exhaust gas filter and an exhaust pipe, throttle valves, non-return valves and the like, even if these are not explicitly described here. Similarly, a turbocharger can have, on the exhaust gas side, a so-called waste-gate valve which is part of a corresponding bypass device and via which at least one of the turbines can be bypassed in a per se known manner, even if this, as described in the foregoing, is not absolutely necessary in this case. In the same way a bypass device can also be provided in the upstream path e.g. for the purpose of bypassing at least one compressor.

It also goes without saying that the elements shown in the exemplary embodiments in FIGS. 3-6 can, of course, also be combined with one another. The numbers specified in the foregoing are also to be understood merely as exemplary. Even though a control device is shown only in FIG. 4, it goes without saying that control devices can likewise be provided in FIGS. 3, 5 and 6 for the purpose of controlling the turbocharger configuration as well as the internal combustion engine.

In all the exemplary embodiments a single-stage turbocharger was always taken as the starting point. It goes without saying that the invention can, of course, also be extended to multi-stage turbocharger configurations. In this situation all the turbines and compressors could be mechanically decoupled from one another in each case. It would likewise be advantageous if, for example, the turbine and the compressor of at least the first turbocharger stage are mechanically coupled to each other and the turbine and the compressor of at least the second turbocharger stage are—as was shown in FIGS. 1 to 6—mechanically decoupled from each other.

The invention has been explained in the foregoing on the basis of a mechanical decoupling of the turbines and the compressor of the same turbocharger stage, wherein said mechanical decoupling is realized by means of an electromechanical coupling. Said electromechanical coupling provides a generator on the turbine side and an electric motor on the compressor side as mechanical elements which are coupled to each other by means of an electrical coupling. Instead of said electromechanical coupling, an (at least partially) pneumatic, hydraulic or other form of coupling that is not exclusively mechanical would also be conceivable.

1-22. (canceled)

23. A turbocharger configuration, comprising:
at least one turbocharger stage having a turbine and a compressor being mechanically decoupled from each other.

24. The turbocharger configuration according to claim 23, wherein said turbine and said compressor of the same turbocharger stage are coupled to each other electromechanically.

25. The turbocharger configuration according to claim 23, wherein said turbine has a first shaft and said compressor has a second shaft being mechanically decoupled from said first shaft.

26. The turbocharger configuration according to claim 25, which further comprises a generator for generating electrical energy from kinetic energy of said turbine, said turbine being mechanically coupled to said generator through at least one of said first shaft or a gear unit.

27. The turbocharger configuration according to claim 25, which further comprises an electric motor for driving said compressor with electrical energy supplied to said electric motor, said compressor being mechanically coupled to said electric motor through at least one of said second shaft or a gear unit.

28. The turbocharger configuration according to claim 25, which further comprises:
a generator for generating electrical energy from kinetic energy of said turbine, said turbine being mechanically coupled to said generator through at least one of said first shaft or a first gear unit;
an electric motor for driving said compressor with electrical energy supplied to said electric motor, said compressor being mechanically coupled to said electric motor through at least one of said second shaft or a second gear unit; and
an electrical coupling device connecting said generator to said electric motor for supplying electrical energy from said generator to said electric motor.

29. The turbocharger configuration according to claim 26, wherein said generator is a synchronous machine or an asynchronous machine.

30. The turbocharger configuration according to claim 27, wherein said electric motor is a synchronous machine or an asynchronous machine.

31. The turbocharger configuration according to claim 26, wherein said gear unit is a speed-reducing gear.

32. The turbocharger configuration according to claim 27, wherein said gear unit is a speed-increasing gear.

33. The turbocharger configuration according to claim 28, wherein said first gear unit is a speed-reducing gear and said second gear unit is a speed-increasing gear.

34. The turbocharger configuration according to claim 28, which further comprises an energy storage device fed by said generator and supplying said electric motor with electrical energy.

35. The turbocharger configuration according to claim 34, wherein said energy storage device is at least one of a storage battery, a supercap capacitor or a high-performance capacitor.

36. The turbocharger configuration according to claim 23, which further comprises a common turbocharger housing in which said compressor and said turbine are integrated.

37. The turbocharger configuration according to claim 23, which further comprises a first housing in which said compressor is disposed, and a second housing, different from said first housing, in which said turbine is disposed.

38. The turbocharger configuration according to claim 23, which further comprises a downstream path constructed without a bypass waste gate, said turbine being disposed in said downstream path.

39. The turbocharger configuration according to claim 23, which further comprises a first turbocharger stage constructed as a high-pressure stage having a high-pressure turbine and a high-pressure compressor, and a second turbocharger stage constructed as a low-pressure stage having a low-pressure turbine and a low-pressure compressor, forming a two-stage turbocharger configuration.

40. The turbocharger configuration according to claim 39, wherein said turbine and said compressor of the same turbocharger stage are coupled to each other at least partially hydraulically or pneumatically.

41. In a motor vehicle, a turbocharger configuration, comprising:
at least one turbocharger stage having a turbine and a compressor being mechanically decoupled from each other.

42. A turbocharger and internal combustion engine assembly, comprising:
an engine having a crankshaft, an air intake manifold and an exhaust manifold; and
a turbocharger configuration according to claim 23 having an upstream path, a downstream path, intake pipes connected between said upstream path and said air intake manifold, and exhaust pipes connected between said downstream path and said exhaust manifold.

43. The assembly according to claim 42, which further comprises:
a first shaft connected to said turbine, and a second shaft connected to said compressor and mechanically decoupled from said first shaft;
a generator for generating electrical energy from kinetic energy of said turbine, said turbine being mechanically coupled to said generator through at least one of said first shaft or a first gear unit, and said generator being part of an alternator;
an electric motor for driving said compressor with electrical energy supplied to said electric motor, said compressor being mechanically coupled to said electric motor through at least one of said second shaft or a second gear unit; and
an electrical coupling device connecting said generator to said electric motor for supplying electrical energy from said generator to said electric motor.

44. The assembly according to claim 43, which further comprises an integrated starter/generator connected to said crankshaft.

45. The assembly according to claim 44, which further comprises supply lines connecting at least one of said generator or said electric motor to said starter/generator.

46. The assembly according to claim 43, which further comprises a control device for controlling at least one of said electric motor or said generator.

47. The assembly according to claim 42, wherein said turbocharger and engine are part of a hybrid drive.
